(19) United States
(12) Patent Application Publication
(10) Pub. No.: US 2016/0305354 A1
(43) Pub. Date: Oct. 20, 2016

(54) GAS FUEL SUPPLY APPARATUS

(71) Applicant: AISAN KOGYO KABUSHIKI KAISHA, Obu-shi (JP)

(72) Inventor: Sadatsugu NAGATA, Aichi-gun (JP)

(73) Assignee: AISAN KOGYO KABUSHIKI KAISHA, Obu-shi (JP)

(21) Appl. No.: 15/083,804

(22) Filed: Mar. 29, 2016

(30) Foreign Application Priority Data
Apr. 15, 2015 (JP) 2015-083080

(51) Int. Cl. F02D 41/00; H01M 8/04746; H01M 8/04089

(52) U.S. Cl. CPC F02D 41/0027; H01M 8/04089; H01M 8/04753; H01M 2250/20

(57) ABSTRACT

A hydrogen supply system includes a hydrogen supply passage connected to a FC stack, a plurality of fuel supply units arranged in parallel with each other in the hydrogen supply passage to supply hydrogen gas to the FC stack through the hydrogen supply passage, and a controller to control operations of the fuel supply units. The fuel supply units include an electrically-operated small-flow regulating valve adjustable to any opening degree between full closed and full open and one or more injectors configured to allow fuel gas to flow at a larger flow rate than a flow rate allowed by the small-flow regulating valve in full open.

### CROSS-REFERENCE TO RELATED APPLICATIONS

This application is based upon and claims the benefit of priority from the prior Japanese Patent Application No. 2015-083080, filed Apr. 15, 2015, the entire contents of which are incorporated herein by reference.

### BACKGROUND OF THE INVENTION

1. Field of the Invention

The present invention relates to a gas fuel supply apparatus for supplying gas fuel to a fuel cell.

2. Related Art

Patent Document 1 discloses a fuel gas flow control device of a fuel cell system in which a plurality of injectors (shutoff valves) are provided. Of these injectors, a small-flow injector having a maximum flow rate lower than other injectors is operated during idling where operating sounds of the injectors are likely to be heard by a driver.

### RELATED ART DOCUMENTS

### Patent Documents

Patent Document 1: Japanese unexamined patent application publication No. 2010-267551

### SUMMARY OF INVENTION

### Problems to be Solved by the Invention

However, when the small-flow injector is operated under duty control, its operating sound and an injection sound of hydrogen gas are generated, which may result in large noise.

The present invention has been made to solve the above problems and has a purpose to provide a gas fuel supply apparatus capable of reducing noise.

### Means of Solving the Problems

To achieve the above purpose, one aspect of the invention provides a gas fuel supply apparatus comprising: a fuel supply passage to be connected to a fuel cell; a plurality of fuel supply units arranged in parallel with each other in the fuel supply passage, the fuel supply units being configured to supply gas fuel to the fuel cell through the supply passage; and a control unit configured to control operations of the fuel supply units, wherein the fuel supply units include an electrically-operated flow regulating valve adjustable to any opening degree between a fully-closed position and a fully-open position, and one or more large-flow fuel supply unit configured to allow gas fuel to flow at a larger flow rate than a flow rate allowed by the flow regulating valve in the fully-open position.

According to the above aspect, the control unit controls operations of the flow regulating valve and the large-flow fuel supply unit so that either or both of the flow regulating valve and the large-flow fuel supply unit are activated as appropriate to supply gas fuel to a fuel cell. Herein, the flow regulating valve can be controlled to adjust its opening degree to any opening degree between a fully-closed position (full closed) and a fully-open position (full open) to thereby regulate a flow rate. This only causes smaller operating sound of the valve or injection sound of gas fuel (which is generated when the gas fuel flows out) as compared with a shutoff valve (e.g., an injector) operated under duty control (i.e., under control by switching an opening degree between full open and full closed) to regulate a flow rate. Accordingly, for example, the flow regulating valve is activated when a small amount of gas fuel is required to be supplied to a fuel cell, so that noise can be reduced. Further, when a flow regulating range of the flow regulating valve is set small, the resolution of this valve can be made small (that is, the opening degree can be adjusted with accuracy). Therefore, for a small supply amount of gas fuel required to be supplied to a fuel cell, for instance, the accuracy of controlling the flow rate of the gas fuel can be improved.

### Effects of the Invention

The gas fuel supply apparatus according to the present invention can reduce noise.

### BRIEF DESCRIPTION OF THE DRAWINGS

FIG. 1 is a schematic configuration diagram of a fuel cell system in an embodiment;

FIG. 2 is a flowchart showing a control method of a hydrogen supply system in the embodiment;

FIG. 3A is a graph showing ON and OFF of operation of an injector and pressure variation of hydrogen gas supplied by the injector;

FIG. 3B is a graph showing ON and OFF of operation of a small-flow regulating valve and pressure variation of hydrogen gas supplied by this valve;

FIG. 4 is a flowchart showing a control method of a hydrogen supply system in a first modified example;

FIG. 5 is a flowchart showing a control method of a hydrogen supply system in a second modified example; and

FIG. 6 is a graph showing operation states of a small-flow regulating valve and a large-flow fuel supply unit and a flow rate of hydrogen gas to be supplied to a FC stack in each operating state of a vehicle.

### DESCRIPTION OF EMBODIMENTS

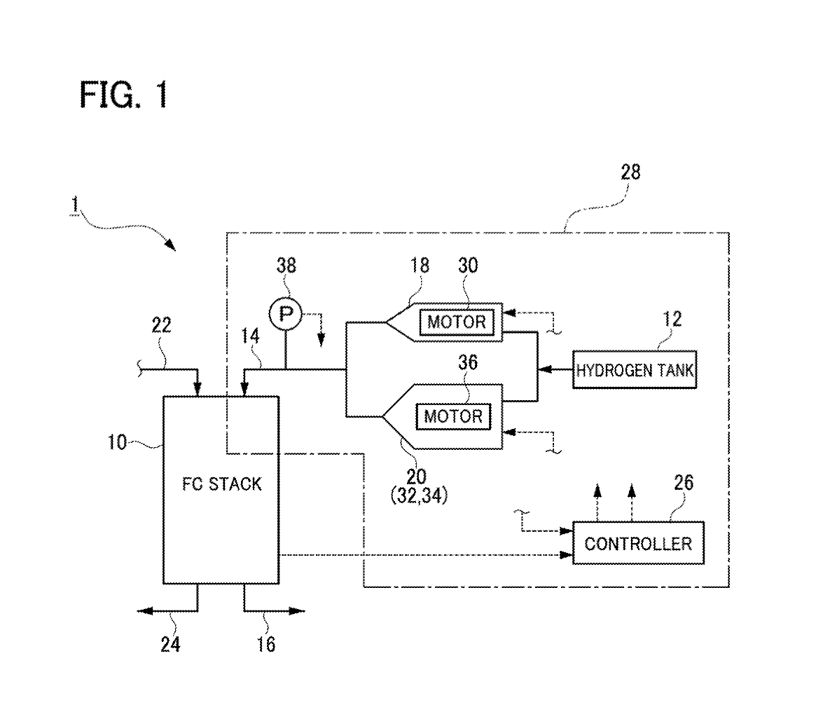

A detailed description of an embodiment of a fuel cell system 1 will now be given referring to the accompanying drawings. As shown in FIG. 1, a fuel cell system 1 includes a FC stack 10 (fuel cells), a hydrogen tank 12, a hydrogen supply passage 14 (a fuel supply passage), a hydrogen discharge passage 16, a small-flow regulating valve 18 (a flow regulating valve), a large-flow fuel supply unit 20, an air supply passage 22, an air discharge passage 24, a controller 26 (a control unit), and others.

This fuel cell system 1 will be mounted in an electric vehicle and used to supply electric power to a drive motor (not shown) for driving the vehicle. The FC stack 10 is supplied with hydrogen gas as gas fuel and air as oxidant gas, and generates power. The power generated in the FC stack 10 is supplied to the drive motor (not shown) through an inverter (not shown).

On an anode side of the FC stack 10, a hydrogen supply system 28 (one example of a gas fuel supply apparatus of the invention) is provided. This hydrogen supply system 28 is provided with the hydrogen tank 12, the hydrogen supply passage 14, and the hydrogen discharge passage 16. The hydrogen tank 12 stores therein high-pressure hydrogen gas. The hydrogen supply passage 14 is a passage connected to the FC stack 10 and used to supply hydrogen gas from the hydrogen tank 12 to the FC stack 10. The hydrogen discharge passage 16 is a passage for discharging hydrogen offgas from the FC stack 10.

The hydrogen supply system 28 includes the small-flow regulating valve 18 and the large-flow fuel supply unit 20, which serve as a plurality of fuel supply units for supplying hydrogen gas to the FC stack 10 through the hydrogen supply passage 14. The small-flow regulating valve 18 and the large-flow fuel supply unit 20 are arranged in parallel with each other in the hydrogen supply passage 14. Further, the small-flow regulating valve 18 and the large-flow fuel supply unit 20 supply hydrogen gas to the FC stack 10 while regulating a flow rate of the hydrogen gas.

The small-flow regulating valve 18 is an electrically-operated flow regulating valve including a valve element (not shown) whose opening degree is adjustable to any opening degree between full closed and full open. Specifically, the small-flow regulating valve 18 is an electrically-operated flow regulating valve configured to control a stroke amount of the valve element to thereby adjust the opening degree. This small-flow regulating valve 18 is provided with a motor 30 serving as an actuator to adjust the opening degree. The small-flow regulating valve 18 may include a solenoid instead of the motor 30.

In the present embodiment, the large-flow fuel supply unit 20 is an injector 32. The injector 32 is an electromagnetic valve configured to allow hydrogen gas to flow at a larger flow rate than a flow rate allowed by the small-flow regulating valve 18 in full open. This injector 32 is an electromagnetic valve configured to switch an opening degree between a fully-closed position (full closed) and a fully-open position (full open). The injector 32 is operated under duty control to regulate a flow rate of hydrogen gas. In the present embodiment, there are provided one or more injectors 32, that is, a single injector 32 or more than one injector (e.g., two or three injectors) 32. As another alternative, four or more injectors 32 may be provided.

On a cathode side of the FC stack 10, in contrast, there are provided the air supply passage 22 for supplying air to the FC stack 10 and the air discharge passage 24 for discharging air offgas from the FC stack 10.

In the foregoing structure, the hydrogen gas fed from the hydrogen tank 12 is supplied to the FC stack 10 by the small-flow regulating valve 18 or the injector(s) 32 through the hydrogen supply passage 14. The hydrogen gas supplied to the FC stack 10 is used to generate power in the FC stack 10 and then discharged as hydrogen offgas from the FC stack 10 through the hydrogen discharge passage 16.

In the foregoing structure, air is supplied to the FC stack 10 through the air supply passage 22. The air supplied to the FC stack 10 is also used to generate power in the FC stack 10 and then discharged as air offgas from the FC stack 10 through the air discharge passage 24.

The fuel cell system 1 is further provided with a controller 26 responsible for control of the system. The controller 26 controls operation of the small-flow regulating valve 18 and operation of the injector 32 in order to control a flow of hydrogen gas to be supplied to the FC stack 10. The controller 26 is provided with a central processing unit (CPU) and a memory. This controller 26 controls the small-flow regulating valve 18 and the injector 32 and others based on a predetermined control program stored in the memory to control a hydrogen gas amount and an air amount to be supplied to the FC stack 10.

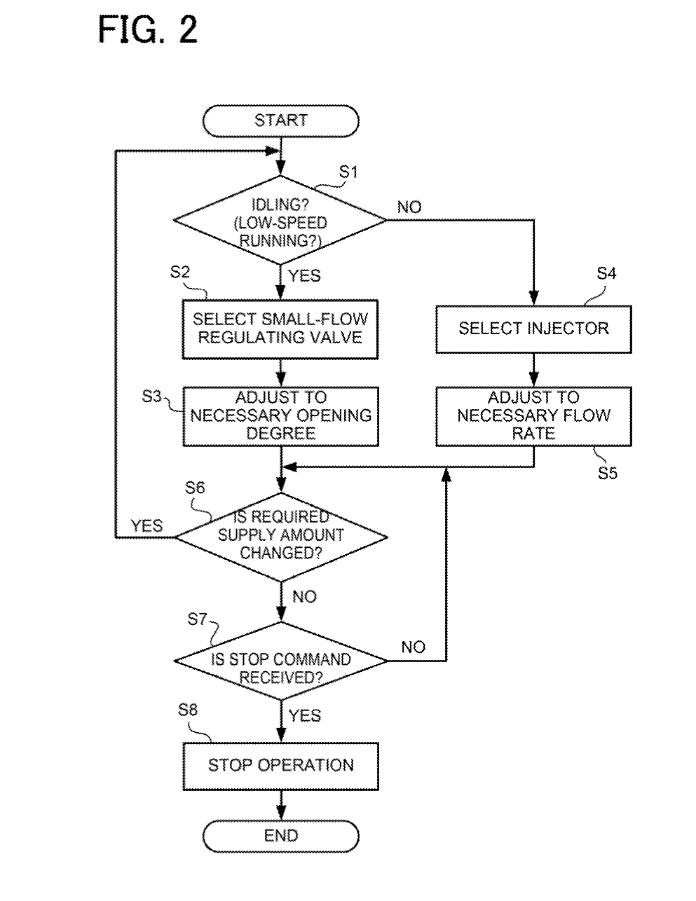

Next, a control method of the hydrogen supply system 28 will be described. In the present embodiment, the controller 26 executes the control shown in FIG. 2 when supplying hydrogen gas to the FC stack 10 is required to start.

As shown in FIG. 2, during idling (YES in step S1) of a vehicle in which the hydrogen supply system 28 is mounted, the controller 26 operates only the small-flow regulating valve 18 as a fuel supply unit for supplying hydrogen gas to the FC stack 10 (step S2). Specifically, during vehicle idling, the controller 26 does not select the injector 32 as the fuel supply unit. The controller 26 adjusts the opening degree of the small-flow regulating valve 18 to a necessary opening degree (an opening degree necessary to ensure a supply amount of hydrogen gas required to be supplied to the FC stack 10) (step S3) to thereby supply the hydrogen gas to the FC stack 10 through the small-flow regulating valve 18.

The term “during idling” in the present specification represents a time period in which hydrogen gas is supplied to the FC stack 10 during vehicle stop. To be more specific, it is a time period in which the FC stack 10 is in a standby operation with minimum reaction gas consumption during vehicle stop.

In contrast, during running of the vehicle (NO in step S1), the controller 26 selects and operates the injector 32 as the fuel supply unit to supply hydrogen gas to the FC stack 10 (step S4). The controller 26 adjusts a flow rate of the injector 32 under duty control to a necessary flow rate (a flow rate necessary to ensure a supply amount of hydrogen gas required to be supplied to the FC stack 10) (step S5) to thereby supply the hydrogen gas to the FC stack 10 through the injector 32.

The controller 26 performs the process in step S1 when the required supply amount of hydrogen gas to the FC stack 10 (i.e., the supply amount of hydrogen gas required to be supplied to the FC stack 10) is changed (YES in step S6) after the opening degree of the small-flow regulating valve 18 is adjusted to the necessary opening degree (step S3) or after the flow rate of the injector 32 is regulated to the necessary flow rate (step S5). On the other hand, when the required supply amount of hydrogen gas to the FC stack 10 is not changed (NO in step S6), the controller 26 performs the process in step S6 in the absence of a command to stop the small-flow regulating valve 18 or the injector 32 (NO in step S7). Upon receiving the command to stop the small-flow regulating valve 18 or the injector 32 (YES in step S7), the controller 26 stops operation of the small-flow regulating valve 18 or the injector 32 (step S8).

Some conditions in the process in FIG. 2 may be changed as below. Specifically, during low-speed running of a vehicle (YES in step S1), the controller 26 may select and operate only the small-flow regulating valve 18 as the fuel supply unit (step S2). On the other hand, during running other than the low-speed running of the vehicle (NO in step S1), the controller 26 may select and operate the injector 32 as the fuel supply unit (step S4). The term “during low-speed running” indicates for example a time period in which a vehicle runs at a speed of 20 to 30 km/h. Further, the term “during running other than low-speed running” indicates for example a time period in which a vehicle runs at a higher speed than 30 km/h.

In the present embodiment, as described above, when the required supply amount of hydrogen gas to the FC stack 10 is smaller than a predetermined amount for example during vehicle idling or during low-speed vehicle running, the controller 26 operates only the small-flow regulating valve 18. Alternatively, when the required supply amount of hydrogen gas to the FC stack 10 is a predetermined amount or more for example during vehicle running and during vehicle running other than low-speed running, the controller 26 operates the injector 32.

According to the present embodiment described above, the plurality of fuel supply units include the electrically-operated small-flow regulating valve 18 whose opening degree is adjustable to any opening degree between full closed and full open and one or more injectors 32 configured to allow hydrogen gas to flow at a larger flow rate than a flow rate allowed by the small-flow regulating valve 18 in full open. Therefore, the controller 26 can control operation of the small-flow regulating valve 18 and operation of the injector 32 so that the small-flow regulating valve 18 and the injector 32 are selectively operated to supply hydrogen gas to the FC stack 10.

Herein, the small-flow regulating valve 18 is configured to adjust its opening degree to any selected opening degree between full closed and full open to thereby regulate a flow rate of hydrogen gas (gas fuel) allowed to flow therethrough. Thus, operating sound of this valve 18 and injection sound of gas fuel are reduced as compared with a shutoff valve (e.g., an injector) operated under duty control (under control by switching an opening degree between full closed and full open) to regulate a flow rate.

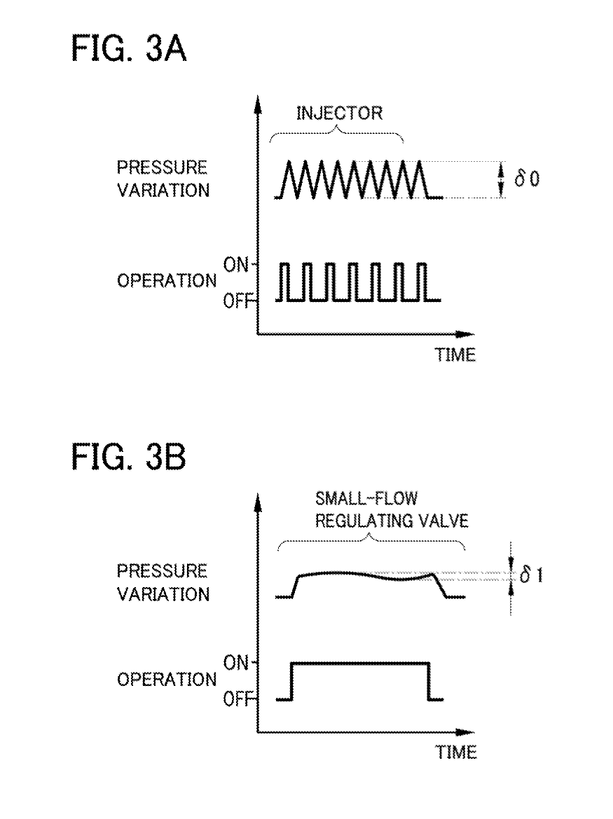

To be concrete, as shown in FIGS. 3A and 3B, assuming that the small-flow regulating valve 18 and the injector 32 are operated to supply hydrogen gas at the same flow rate as each other, the number of times the operation of the small-flow regulating valve 18 is switched between ON and OFF is smaller than the number of times the operation of the injector 32 is switched between ON and OFF. Herein, the term “the number of times the operation is switched between ON and OFF” indicates the number of operations switched between activation and stop. While hydrogen gas is being supplied, a pressure variation range δ1 of the hydrogen gas supplied through the small-flow regulating valve 18 is smaller than a pressure variation range δ0 of hydrogen gas supplied through the injector 32. Therefore, the small-flow regulating valve 18 generates smaller operating sound and hydrogen gas injection sound than those caused by the injector 32.

Accordingly, during idling of a vehicle or during low-speed running of a vehicle where a supply amount of hydrogen gas required to be supplied to the FC stack 10 is small and thus noise is hardly heard by a driver of the vehicle, the small-flow regulating valve 18 is operated, so that noise can be reduced. When the flow regulating range of the small-flow regulating valve 18 is set small, the resolution of this valve 18 can be made small (i.e., the opening degree can be adjusted with accuracy). Therefore, when a small supply amount of gas fuel is required to be supplied to the FC stack 10, the accuracy of controlling the flow rate of the hydrogen gas can be improved.

The small-flow regulating valve 18 is provided with the motor 30 or a solenoid to adjust the opening degree. Accordingly, the opening degree of the small-flow regulating valve 18 can be accurately adjusted with the motor 30 or the solenoid, so that the small-flow regulating valve 18 can perform flow rate control with enhanced accuracy.

The controller 26 operates only the small-flow regulating valve 18 during vehicle idling or during low-speed vehicle running. When it is necessary to supply hydrogen gas to the FC stack 10 while running sound of the vehicle such as road noise does not occur or while the running sound is small, only the small-flow regulating valve 18 is operated in light of its smaller operating sound and hydrogen gas injection sound than the injector 32. This can reduce noise and thus suppress uncomfortable feeling of a driver due to such noise.

The controller 26 operates the injector 32 during vehicle running or during vehicle running other than low-speed running. Accordingly, when a supply amount of hydrogen gas required to be supplied to the FC stack 10 is large, for example, during vehicle running or during vehicle running other than low-speed running, a large amount of hydrogen gas can be supplied to the FC stack 10 through the injector 32. This can ensure a required supply amount of hydrogen gas to the FC stack 10.

Further, the injector 32 is an electromagnetic valve that is operated under duty control. Thus, a duty ratio is set large for a large amount of hydrogen gas required to be supplied to the FC stack 10, so that the hydrogen gas can be supplied with good response to the FC stack 10. Using an inexpensive injector 32 can also reduce cost.

Next, a first modified example of the present embodiment will be described below. In this modified example, the large-flow fuel supply unit 20 is a large-flow regulating valve 34. This large-flow regulating valve 34 is a flow regulating valve configured to allow fuel gas to flow at a larger flow rate than a flow rate allowed by the small-flow regulating valve 18 in full open. The large-flow regulating valve 34 is an electrically-operated flow regulating valve that includes a motor 36 and a valve element (not shown) whose opening degree is adjustable to any opening degree between full closed and full open. A flow regulating range of the large-flow regulating valve 34 is larger than a flow regulating range of the small-flow regulating valve 18.

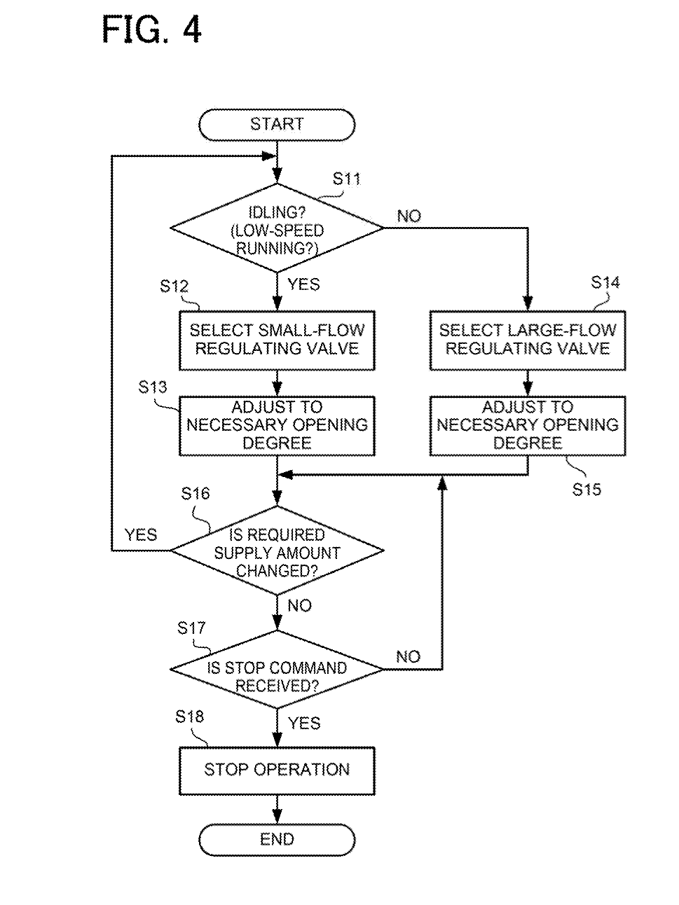

In this modified example, the controller 26 executes the control shown in FIG. 4 when supplying hydrogen gas to the FC stack 10 is required to start. As shown in FIG. 4, during running of a vehicle (NO in step S11), the controller 26 selects and operates the large-flow regulating valve 34 as the fuel supply unit (step S14). The controller 26 adjusts the opening degree of the large-flow regulating valve 34 to a necessary opening degree (step S15) and supplies hydrogen gas to the FC stack 10 through the large-flow regulating valve 34. Other processes in FIG. 4 are the same as those in FIG. 2.

The hydrogen supply system 28 in this modified example includes the small-flow regulating valve 18 and the large-flow regulating valve 34 which provide different flow regulating ranges of hydrogen gas. Thus, irrespective of a flow rate of hydrogen gas, large or small, good responsivity in the flow rate control of hydrogen gas is achieved.

According to the present modified example, the large-flow fuel supply unit 20 is the electrically-operated large-flow regulating valve 34 whose opening degree is adjustable to any selected opening degree between full closed and full open. Accordingly, components of the small-flow regulating valve 18 and components of the large-flow regulating valve 34 can be commonalized, resulting in reduced cost. For instance, if the small-flow regulating valve 18 and the large-flow regulating valve 34 are configured to be different from each other only in stroke amount of the valve element (not shown), most of their components can be commonalized. This can achieve further cost reduction. Moreover, the small-flow regulating valve 18 can maintain the accuracy of controlling the flow rate of the hydrogen gas when the required supply amount of hydrogen gas to the FC stack 10 is small, while the large-flow regulating valve 34 can supply a large amount of hydrogen gas to the FC stack 10 when the required supply amount of hydrogen gas to the FC stack 10 is large.

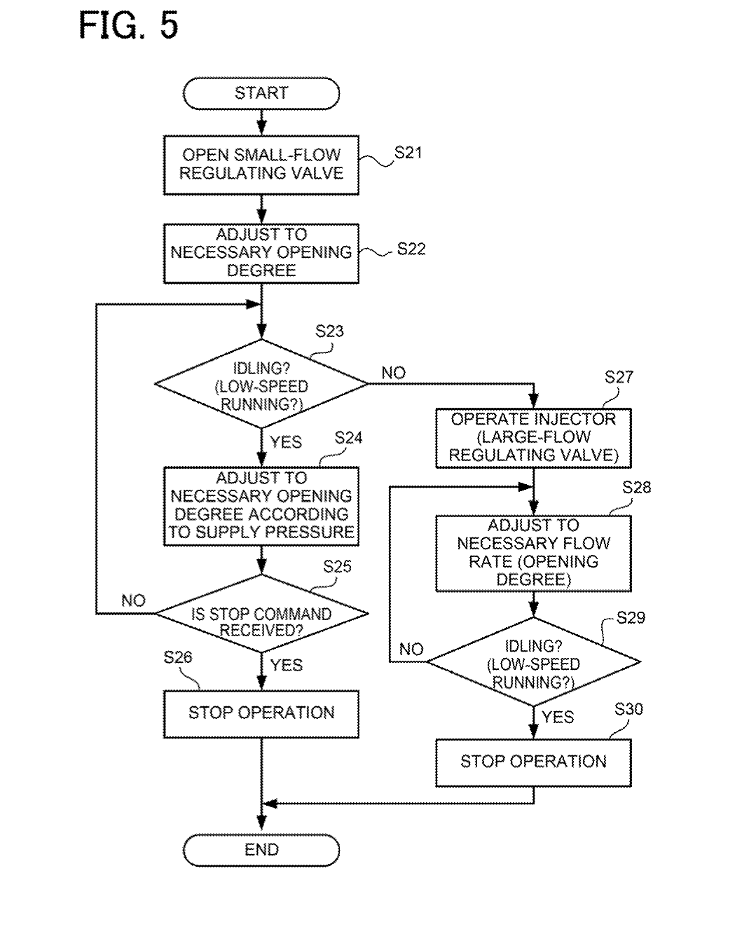

A second modified example of the embodiment will be described below. In this modified example, the controller 26 performs the control shown in FIG. 5 when supplying hydrogen gas to the FC stack 10 is required to start.

As shown in FIG. 5, the controller 26 causes the small-flow regulating valve 18 to open so that the opening degree of this valve 18 is adjusted to a necessary opening degree (step S21 and step S22). The controller 26 then supplies hydrogen gas to the FC stack 10 through the small-flow regulating valve 18. In the present modified example, as above, the controller 26 continuously holds the small-flow regulating valve 18 in an operation ON state during supplying of hydrogen gas to the FC stack 10.

Next, during idling of a vehicle (YES in step S23), the controller 26 adjusts the opening degree of the small-flow regulating valve 18 to a necessary opening degree according to supply pressure (step S24). In step S24, specifically, the controller 26 adjusts the opening degree of the small-flow regulating valve 18 so as to ensure a supply amount of hydrogen gas required to be supplied to the FC stack 10 by reading the supply pressure. Herein, the term “supply pressure” indicates the pressure of hydrogen gas flowing in the hydrogen supply passage 14 between the small-flow regulating valve 18 and the FC stack 10.

Preferably, at predetermined time intervals, the controller 26 obtains a required supply amount of hydrogen gas to the FC stack 10 and adjusts the opening degree of the small-flow regulating valve 18 based on the obtained required supply amount. The supply pressure is measured by a pressure sensor 38 (see FIG. 1) provided in the hydrogen supply passage 14 between the small-flow regulating valve 18 and the FC stack 10.

Subsequently, in the absence of a command to stop the small-flow regulating valve 18 (NO in step S25), the controller 26 performs the process in step S23. In contrast, when receiving the command to stop the small-flow regulating valve 18 (YES in step S25), the controller 26 stops operation of the small-flow regulating valve 18 (step S26).

During running of the vehicle (NO in step S23), the controller 26 operates the injector 32 (step S27) to regulate a flow rate of the injector 32 under duty control to a necessary flow rate (step S28). Accordingly, during vehicle running, the controller 26 operates the small-flow regulating valve 18 and further operates the injector 32. As an alternative, the large-flow regulating valve 34 may be provided instead of the injector 32. In this case, in step S28, the controller 26 operates the large-flow regulating valve 34 to adjust an opening degree of the valve 34 to a necessary opening degree.

When the vehicle is running (NO in step S29), the process in step S28 is performed. Alternatively, when the vehicle is idling (YES in step S29), the injector 32 is stopped operating (step S30).

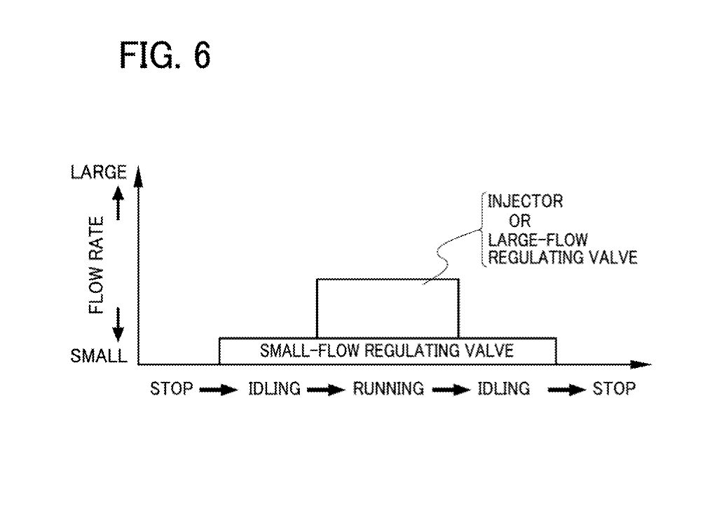

By the control shown in FIG. 5, the flow rate of hydrogen gas to be supplied to the FC stack 10 is controlled for example as shown in FIG. 6. Specifically, as shown in FIG. 6, when a vehicle state is changed from stop to idling, the small-flow regulating valve 18 is started to operate, thereby supplying hydrogen gas to the FC stack 10. Then, when the vehicle state is further changed from idling to running, the injector 32 or the large-flow regulating valve 34 is started to operate together with the small-flow regulating valve 18 to supply hydrogen gas to the FC stack 10. Thereafter, when the vehicle state is changed from running to idling, the injector 32 or the large-flow regulating valve 34 is stopped and only the small-flow regulating valve 18 remains in the ON state to supply hydrogen gas to the FC stack 10. Further, when the vehicle state is changed from idling to stop, the small-flow regulating valve 18 is stopped, i.e., turned into an OFF state.

Some conditions in the process in FIG. 5 may be changed as below. For instance, during low-speed running of the vehicle (YES in step S23), the controller 26 may adjust the opening degree of the small-flow regulating valve 18 to a necessary opening degree according to the supply pressure (step S24). During vehicle running other than low-speed running (NO in step S23), the controller 26 also may operate the injector 32 (step S27). The controller 26 may further perform the process in step S28 during the vehicle running other than low-speed running (NO in step S29), while stopping operation of the injector 32 during low-speed running of the vehicle (YES in step S29).

According to the second modified example, the controller 26 continuously operates the small-flow regulating valve 18 during supplying of hydrogen gas to the FC stack 10. During vehicle running or during vehicle running other than low-speed running, the controller 26 operates the injector 32 or the large-flow regulating valve 34. In this modified example, accordingly, when it is necessary to supply hydrogen gas to the FC stack 10, irrespective of during vehicle stop or during vehicle, the small-flow regulating valve 18 is continuously operated to supply hydrogen gas to the FC stack 10. Therefore, when the vehicle is changed from a running state to an idling state, the injector 32 has only to be stopped operating or the large-flow regulating valve 34 has only to be closed, so that an amount of hydrogen gas required for idling can be supplied to the FC stack 10. Thus, the responsivity of supplying hydrogen gas to the FC stack 10 can be ensured.

Further, at the predetermined time intervals, the controller 26 obtains a required supply amount of hydrogen gas to the FC stack 10 and adjusts the opening degree of the small-flow regulating valve 18 based on the obtained required supply amount. Accordingly, the frequency of adjusting the opening degree of the small-flow regulating valve 18 can be reduced as compared with a case where the opening degree of the small-flow regulating valve 18 is constantly adjusted according to the required supply amount of hydrogen gas to the FC stack 10. This can suppress consumption of required power such as necessary electric current to adjust the opening degree of the small-flow regulating valve 18.

The foregoing embodiments are mere examples and give no limitation to the present invention. The present invention may be embodied in other specific forms without departing from the essential characteristics thereof.

### REFERENCE SIGNS LIST

1 Fuel supply system

10 FC stack

12 Hydrogen tank

14 Hydrogen supply passage

16 Hydrogen discharge passage

18 Small-flow regulating valve

20 Large-flow fuel supply unit

22 Air supply passage

24 Air discharge passage

26 Controller

28 Hydrogen supply system

30 Motor

32 Injector

34 Large-flow regulating valve

36 Motor

38 Pressure sensor

δ0 Pressure variation range

δ1 Pressure variation range

What is claimed is:

1. A gas fuel supply apparatus comprising:
a fuel supply passage to be connected to a fuel cell;
a plurality of fuel supply units arranged in parallel with each other in the fuel supply passage, the fuel supply units being configured to supply gas fuel to the fuel cell through the supply passage; and
a control unit configured to control operations of the fuel supply units,
wherein the fuel supply units include an electrically-operated flow regulating valve adjustable to any opening degree between a fully-closed position and a fully-open position, and one or more large-flow fuel supply unit configured to allow gas fuel to flow at a larger flow rate than a flow rate allowed by the flow regulating valve in the fully-open position.

2. The gas fuel supply apparatus according to claim 1, wherein the flow regulating valve includes a motor or a solenoid for adjusting the opening degree.

3. The gas fuel supply apparatus according to claim 1, wherein the control unit is configured to operate only the flow regulating valve during idling of a vehicle in which the gas fuel supply apparatus is mounted or during low-speed running of the vehicle.

4. The gas fuel supply apparatus according to claim 3, wherein the control unit is configured to operate the large-flow fuel supply unit during running of the vehicle or during running other than low-speed running of the vehicle.

5. The gas fuel supply apparatus according to claim 1, wherein
the control unit continuously operates the flow regulating valve during supplying of the gas fuel to the fuel cell, and
the control unit operates the large-flow fuel supply unit during running of a vehicle in which the gas fuel supply apparatus is mounted or during running other than low-speed running of the vehicle.

6. The gas fuel supply apparatus according to claim 5, wherein the control unit obtains a required supply amount of the gas fuel to the fuel cell at a predetermined time interval and adjusts the opening degree of the flow regulating valve based on the obtained required supply amount.

7. The gas fuel supply apparatus according to claim 1, wherein the large-flow fuel supply unit is an electromagnetic valve that is operated under duty control.

8. The gas fuel supply apparatus according to claim 1, wherein the large-flow fuel supply unit is an electrically-operated large-flow regulating valve adjustable to any opening degree between a fully-closed position and a fully-open position.
